(19) United States
(12) Patent Application Publication
(10) Pub. No.: US 2025/0207863 A1
(43) Pub. Date: Jun. 26, 2025

(54) SPIRAL GRAVITY FED HEAT EXCHANGER

(71) Applicant: X Development LLC, Mountain View, CA (US)

(72) Inventor: Robert Nelson, Palo Alto, CA (US)

(73) Assignee: X Development LLC, Mountain View, CA (US)

(21) Appl. No.: 18/988,502

(22) Filed: Dec. 19, 2024

Related U.S. Application Data
(60) Provisional application No. 63/613,635, filed on Dec. 21, 2023.

(51) Int. Cl. F28D 7/04

(52) U.S. Cl. CPC F28D 7/04

(57) ABSTRACT

A system for transferring heat between fluid and a bulk solid. The system includes a plurality of heat exchanger units, each heat exchanger unit comprising: an annular structure including an inner shell and an outer shell; and a first plate and a second plate defining therebetween a conduit for transporting the fluid, wherein the conduit forms a spiral around the inner shell, the spiral extending from the inner shell towards the outer shell, a space between turns of the spiral defining a channel for passage of the bulk solid. The inner shell defines a cylindrical annulus of the annular structure, an axis of the cylindrical annulus being aligned with the direction of gravity during operation. The bulk solid comprises a sorbent material configured to adsorb carbon dioxide from air. The fluid comprises a cooling fluid or a heating fluid.

### CROSS REFERENCE TO RELATED APPLICATIONS

This application claims priority under 35 U.S.C. 119(e) to U.S. Provisional Application Ser. No. 63/613,635, entitled “Spiral Gravity Fed Heat Exchanger,” by Robert Nelson, filed on Dec. 21, 2023, the contents of which are herein incorporated by reference.

### TECHNICAL FIELD

This specification relates generally to processes, methods, and systems for desorbing carbon dioxide from bulk solids by transferring heat between fluids and the bulk solids.

### BACKGROUND

Fossil fuels currently supply the majority of the world's energy needs, and their combustion produces carbon dioxide emissions. Carbon dioxide is a greenhouse gas and is believed to contribute to global climate change. Concern over global climate warming has led to interest in capturing carbon dioxide emissions from fluid streams. Carbon dioxide can be removed from fluid streams by various methods such as through adsorbent by a solid. The solid then releases the carbon dioxide when heated.

### SUMMARY

In general, this disclosure relates to a spiral gravity-fed system for desorption of carbon dioxide. An example system includes multiple spiral heat exchanger units that are each configured to transfer heat between a free-flowing bulk solid and a fluid as the bulk solid flows downwards through channels of the heat exchanger unit in the direction of gravity. The heat exchanger units are stacked such that the bulk solid moves between heat exchanger units due to gravity.

In some examples, a first subset of the multiple spiral heat exchanger units form a heating region in which a heating fluid is circulated to cause the bulk solid to release gasses. A second subset of the multiple spiral heat exchanger units form a cooling region in which a cooling fluid is circulated to cool the bulk solid. The heating region can include one or more heat exchanger units that compose a dryer that evaporates water vapor from the bulk solid. The heating region can include one or more heat exchanger units that compose a desorber that removes carbon dioxide from the bulk solid.

In a heat exchanger unit, the fluid (e.g., heating fluid or cooling fluid) circulates through spiral-shaped conduits between an inner cylindrical shell and a concentric, cylindrical outer shell. The fluid can circulate through the conduit in an inward direction towards the inner shell, in an outward direction towards the outer shell, or can circulate inward in a first conduit layer and outward in a second conduit layer.

The inner shells of the heat exchanger units define a central tube that can house fluid piping. The central tube is in fluid communication with the bulk solid channels of the heat exchanger units. The heat exchanger includes gas extraction regions in between the heat exchanger units. The central tube is maintained at vacuum pressures for removing gasses from the bulk solid as the bulk solid flows through the channels and through the gas extraction regions between the heat exchanger units. The gas extraction regions include funneling elements that funnel the bulk solid away from the inner and outer shell, increasing a surface area of the bulk solid that is exposed to vacuum.

The heat exchanger is an indirect liquid-to-solid heat exchanger. In some examples, the bulk solid is a sorbent material that adsorbs and desorbs carbon dioxide. The sorbent material can have a powdered or pelletized form. In some examples, the sorbent material includes silica-based pellets.

In general, innovative aspects of the subject matter described in this specification can be embodied in a system for transferring heat between fluid and a bulk solid. The system includes: a plurality of heat exchanger units, each heat exchanger unit including: an annular structure including an inner shell and an outer shell; and a first plate and a second plate defining therebetween a conduit for transporting the fluid. The conduit forms a spiral around the inner shell, the spiral extending from the inner shell towards the outer shell, a space between turns of the spiral defining a channel for passage of the bulk solid.

These and other embodiments can include the following features, alone or in any combination. In some implementations, the inner shell defines a cylindrical annulus of the annular structure, an axis of the cylindrical annulus being aligned with the direction of gravity during operation.

In some implementations, during operation, the bulk solid enters the channel at a first end of the channel and exits the channel at a second end of the channel, the bulk solid passing from the first end of the channel to the second end of the channel due to gravity.

In some implementations, the plurality of heat exchanger units are stacked such that, during operation, the bulk solid moves from a first channel of a first heat exchanger unit to a second channel of a second heat exchanger unit due to gravity.

In some implementations, the first heat exchanger unit includes a gas extraction region between the inner shell and the outer shell. During operation, the bulk solid passes from the first channel through the gas extraction region to the second channel due to gravity.

In some implementations, the first heat exchanger unit includes a gas extraction region between the inner shell and the outer shell. During operation, the bulk solid passes from the second end of the first channel to the gas extraction region due to gravity.

In some implementations, the inner shell defines an annulus of the annular structure, the inner shell including a plurality of openings that permit passage of gasses from the gas extraction region to the cylindrical annulus.

In some implementations, the system includes a housing enclosing the outer shell, the system including an outer ring region between the outer shell and the housing, the outer shell including a plurality of openings that permit passage of gasses from the gas extraction region to the outer ring region.

In some implementations, the plurality of openings are substantially aligned with the gas extraction region in a plane perpendicular to the direction of gravity.

In some implementations, the first heat exchanger unit includes a funneling element in the gas extraction region configured to funnel the bulk solid after the bulk solid exits the first channel at the second end of the first channel.

In some implementations, the funneling element includes an inner funnel member attached to the inner shell and an outer funnel member attached to the outer shell, the inner funnel member and the outer funnel member configured to funnel the bulk solid away from the inner shell and away from the outer shell.

In some implementations, during operation, gas is extracted from the bulk solid as the bulk solid passes through the gas extraction region.

In some implementations, the gas includes at least one of water vapor or carbon dioxide.

In some implementations, the inner shell and the outer shell are concentric.

In some implementations, the inner shell includes an inlet aperture for ingress of the fluid into the conduit and an outlet aperture for egress of the fluid from the conduit.

In some implementations, the outer shell includes inlet aperture for ingress of the fluid into the conduit and an outlet aperture for egress of the fluid from the conduit.

In some implementations, the inner shell includes inlet aperture for ingress of the fluid into the conduit and the outer shell includes an outlet aperture for egress of the fluid from the conduit.

In some implementations, the inner shell includes inlet aperture for ingress of the fluid into the conduit and the outer shell includes an outlet aperture for egress of the fluid from the conduit.

In some implementations, the system includes a metering device configured to control a flow of the bulk solid into the channel.

In some implementations, the bulk solid includes a sorbent material.

In some implementations, the sorbent material has a pelletized form.

In some implementations, the sorbent material is configured to adsorb carbon dioxide from air.

In some implementations, the fluid includes a cooling fluid or a heating fluid.

In some implementations, the system includes a heating region including a first subset of the plurality of heat exchanger units. A first fluid transported through respective conduits of the first subset of the plurality of heat exchanger units includes a heating fluid. The system includes a cooling region including a second subset of the plurality of heat exchangers. A second fluid transported through respective conduits of the second subset of the plurality of heat exchanger units includes a cooling fluid.

In some implementations, during operation, the heating region has a higher elevation than the cooling region.

In some implementations, the system includes: a system inlet providing access for delivery of the bulk solid; and a system outlet providing egress for removal of the bulk solid. During operation, the system inlet has a higher elevation than the system outlet.

In some implementations, the conduit and the channel are fluidly isolated from each other.

In general, innovative aspects of the subject matter described in this specification can be embodied in a method for transferring heat between fluid and a bulk solid. The method includes circulating a fluid through a conduit within an annular structure including an inner shell and an outer shell, the conduit being between a first plate and a second plate. The conduit forms a spiral around the inner shell, the spiral extending from the inner shell towards the outer shell. The method includes feeding the bulk solid into a channel defined by space between turns of the spiral.

These and other embodiments can include the following features, alone or in any combination. In some implementations, the inner shell defines an annulus of the annular structure, the annulus being in fluid communication with the channel, the method including establishing vacuum pressure in the annulus.

In some implementations, the method includes evaporating water from the bulk solid by transferring heat from the fluid to the bulk solid during passage of the bulk solid through the channel.

In some implementations, the method includes desorbing carbon dioxide from the bulk solid by transferring heat from the fluid to the bulk solid during passage of the bulk solid through the channel.

In some implementations, the method includes cooling the bulk solid by transferring heat from the bulk solid to the fluid during passage of the bulk solid through the channel.

In some implementations, the method includes circulating the fluid through the conduit from an inlet aperture at the inner shell to an outlet aperture at the outer shell.

In some implementations, the method includes circulating the fluid through the conduit from an inlet aperture at the outer shell to an outlet aperture at the inner shell.

In some implementations, the conduit includes a first conduit layer and a second conduit layer, the first conduit layer and the second conduit layers being in fluid communication and having different elevations. The method includes circulating the fluid through the first conduit layer from an inlet aperture at the inner shell towards the outer shell; and circulating the fluid through the second conduit layer from the outer shell to an outlet aperture at the inner shell.

In some implementations, the conduit includes a first conduit layer and a second conduit layer, the first conduit layer and the second conduit layers being in fluid communication and having different elevations. The method includes circulating the fluid through the first conduit layer from an inlet aperture at the outer shell towards the inner shell; and circulating the fluid through the second conduit layer from the inner shell to an outlet aperture at the outer shell.

In some implementations, the bulk solid moves through the channel due to gravity.

The disclosed systems and methods can result in the following advantages. Removing water from the bulk solid in the dryer prior to delivering the bulk solid to the desorber improves the efficiency of desorption of carbon dioxide from the bulk solid in the desorber. Performing evaporation and desorption at vacuum pressures reduces the temperature at which the processes occur. Indirect heating by conduction makes it possible to capture and use low-grade heat for heating bulk solid adsorbent material. Using waste heat as a heat source improves efficiency of industrial processes.

Due to the vertically oriented modular design with few moving parts or no moving parts, maintenance costs can be reduced. Routing fluid piping through a central tube of the heat exchanger and/or through an outer ring of the heat exchanger reduces the number of penetrations in a housing of the heat exchanger. The cylindrical-shaped heat exchanger can be sized to fit into a vacuum casing or pressure vessel.

Using multiple stacked heat exchanger units with different fluid piping connections enables heating and cooling of the bulk solid in the same heat exchanger. Extracting gasses from the bulk solid in gas extraction regions between the heat exchanger units increases the contact area of bulk solid to vacuum pressures per unit of height. Funneling the bulk solid in the gas extraction region increases the surface area of the bulk solid that is exposed to vacuum pressure and prevents clogging opening between the central tube and the gas extraction region.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 illustrates an example spiral gravity fed heat exchanger for carbon desorption.

FIG. 2 is a schematic diagram of an example spiral gravity fed heat exchanger for carbon desorption.

FIG. 3A illustrates a perspective view of an example heat exchanger unit of a heat exchanger.

FIG. 3B illustrates a perspective view of a cross section of an example heat exchanger unit having fluid connections at an inner shell.

FIG. 3C illustrates a perspective view of a cross section of an example heat exchanger unit having fluid connections at an outer shell.

FIG. 3D illustrates an overhead view of an example heat exchanger unit having fluid connections at an outer shell.

FIG. 4A is a schematic illustration of an example implementation of a carbon dioxide production system according to the present disclosure.

FIG. 4B is a schematic illustration of an example implementation of a carbon dioxide direct air capture system according to the present disclosure.

Like reference symbols in the various drawings indicate like elements.

### DETAILED DESCRIPTION

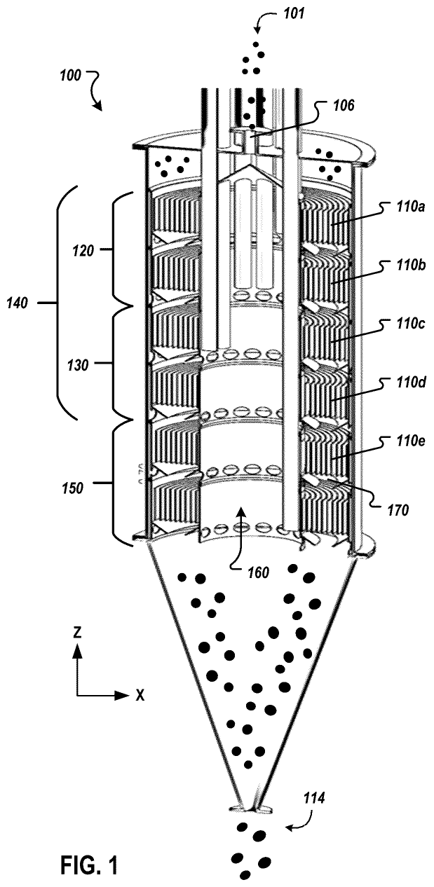

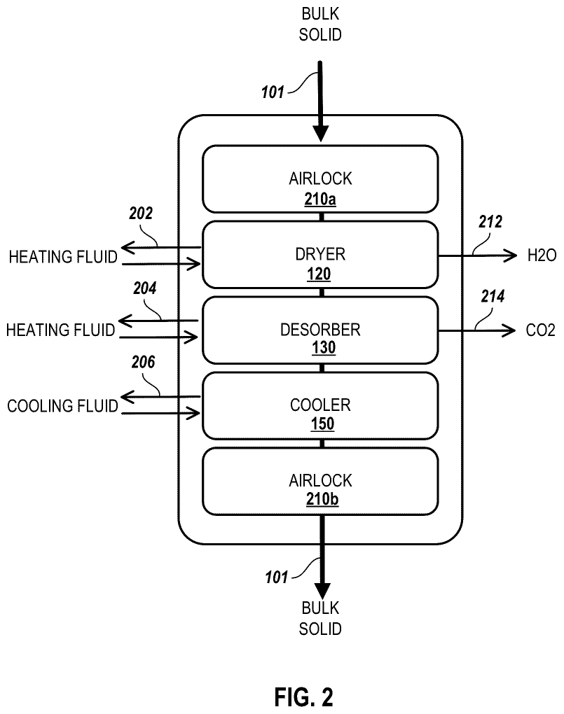

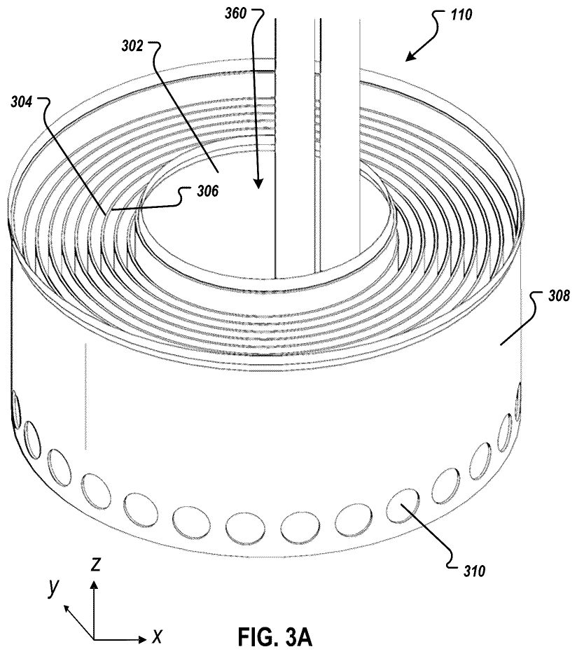

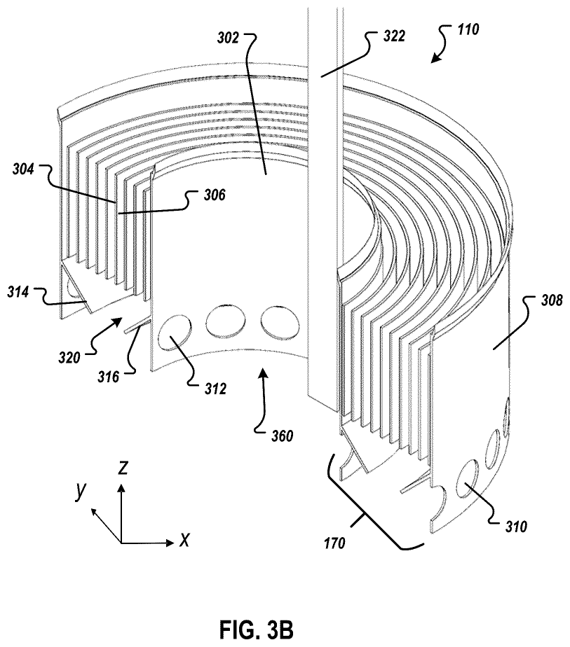

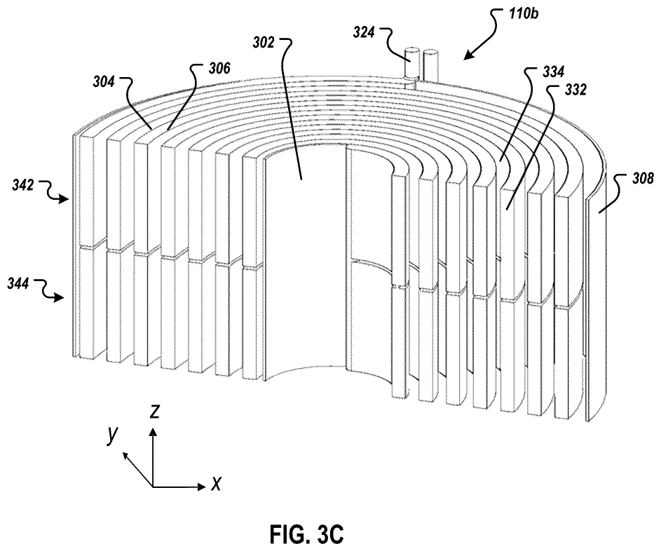

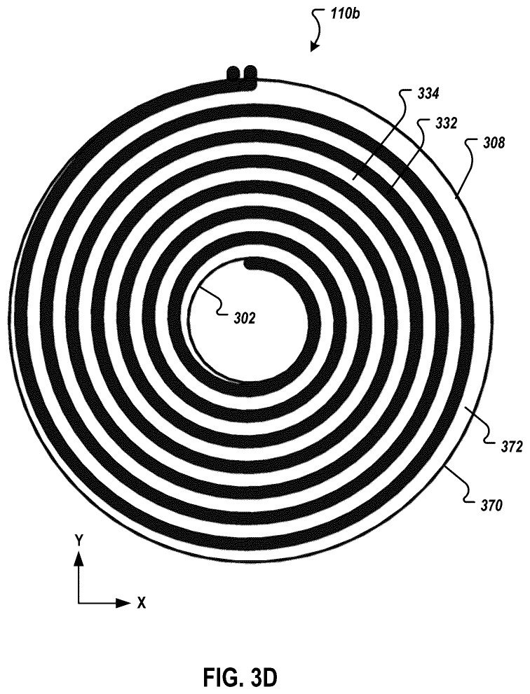

FIG. 1 illustrates an example spiral gravity fed heat exchanger 100 for carbon desorption. FIG. 2 is a schematic diagram of an example spiral gravity fed heat exchanger for carbon desorption. Operations of the heat exchanger 100 will be described in general with reference to FIGS. 1 and 2. Components of the heat exchanger 100 will be described in greater detail with reference to FIGS. 3A-3B.

The heat exchanger 100 is a system for removing carbon dioxide from a sorbent material in the form of a bulk solid 101. Specifically, the sorbent material can be a free flowing bulk solid in a powdered or pelletized form. In some examples, the bulk solid 101 includes silica-based pellets. A mass flow discharge feeder at an outlet of the heat exchanger 100 can creates uniform product velocity and regulate product flow rate. The bulk solids pass through the heat exchanger 100 by gravity, using no moving parts.

The heat exchanger 100 includes multiple heat exchanger units 110. The heat exchanger units 110 are stacked such that, during operation, the bulk solid 101 flows between the heat exchanger units 110 due to gravity. For example, the bulk solid flows from heat exchanger unit 110a to heat exchanger unit 110b in the direction of gravity (e.g., downward in the z-direction). The heat exchanger 100 includes gas extraction regions 170 between each of the heat exchanger units 110. A funneling element is positioned in each gas extraction region 170. During operation, gas is extracted from the bulk solid 101 as the bulk solid 101 passes through the gas extraction regions 170.

The heat exchanger units 110 can each have an annular shape defining an annulus. When the heat exchanger units 110 are stacked, the annuluses of the heat exchanger units 110 form a central tube 160. During operation, the central tube 160 can be maintained under vacuum pressure. Gasses can be removed from the central tube 160 through vacuum suction. The heat exchanger 100 includes openings between the central tube 160 and the gas extraction regions 170 in between the heat exchanger units 110. The heat exchanger units 110 are described in greater detail with reference to FIGS. 3A to 3D.

Prior to being introduced to the heat exchanger 100, the bulk solid 101 can undergo an adsorption process. During the adsorption process, the bulk solid 101 can adsorb carbon dioxide from a fluid such as an air stream.

The heat exchanger 100 includes a heating region 140 including a dryer 120 and a desorber 130. The heat exchanger 100 includes a cooling region (“cooler”) 150. The heating region 140 and the cooler 150 each include one or more heat exchanger units 110. In the example of FIG. 1, the heat exchanger 100 includes six heat exchanger units 110a-f. The heating region 140 includes two heat exchanger units 110a, 110b that are included in the dryer 120, two heat exchanger units 110c, 110d that are included in the desorber 130, and two heat exchanger units 110e, 110f that are included in the cooler 150. The dryer 120, the desorber 130, and the cooler 150 can each include more or fewer heat exchanger units 110.

Referring to FIG. 2, the dryer 120 is configured to evaporate water vapor from the bulk solid 101 by transferring heat from heating fluid 202 to the bulk solid 101. The desorber 130 is configured to desorb carbon dioxide from the bulk solid 101 by transferring heat from heating fluid 204 to the bulk solid 101. The heating fluid 202 circulated in the dryer 120 and the heating fluid 204 circulated in the desorber 130 can be the same heating fluid or different heating fluid. The heating fluid can be a liquid such as water.

Referring back to FIG. 1, wet and rich bulk solid 101 can be delivered to the heating region 140 through a heat exchanger inlet 106. Bulk solid can be considered wet when the bulk solid contains water moisture. Bulk solid can be considered dry when the bulk solid releases water moisture. Bulk solid can be considered rich when the bulk solid contains carbon dioxide. Bulk solid can be considered lean when the bulk solid releases carbon dioxide.

The heat exchanger inlet 106 provides access for delivery of the wet and rich bulk solid 101 to the heating region 140. In some examples, the inlet 106 is near or at the top of the heating region 140 with respect to the direction of gravity (e.g., downwards in the z-direction). The bulk solid 101 enters the heating region 140 through the inlet 106 and flows downward through the heating region 140 due to gravity.

Inside the dryer 120 of the heating region 140, the heating fluid transfers heat to the wet and rich bulk solid 101. The wet and rich bulk solid 101 releases water vapor into the heating region 140 under the vacuum conditions due to the increased temperatures in the heating region 140. The wet and rich bulk solid 101 becomes dry and rich bulk solid 101 that is dry of water and rich in carbon dioxide. Dry and rich bulk solid 101 exits the dryer 120 at approximately 25 C or greater (e.g., 30 C or greater, 35 C or greater, 40 C or greater), and is gravity fed from the dryer 120 to the desorber 130.

Dry and rich bulk solid 101 flows downward through the heating region 140 from the dryer 120 to the desorber 130 due to gravity. Under vacuum conditions at higher temperatures, the bulk solid 101 releases carbon dioxide. Inside the desorber 130, the bulk solid 101 flows through the channel, absorbing heat from the heating fluid. The bulk solid 101, heated by the heating fluid, rises to a temperature of approximately 70 C or greater (e.g., 75 C or greater, 80 C or greater, 85 C or greater). Under vacuum conditions at these temperatures, the bulk solid 101 releases carbon dioxide into the heat exchanger 100. The desorber 130 removes carbon dioxide from the bulk solid 101 by transferring heat from the heating fluid to the bulk solid 101. The dry and rich bulk solid 101 becomes dry and lean bulk solid 101 that is dry of water and lean in carbon dioxide.

Referring to FIG. 2, in some examples, the heat exchanger 100 includes one or more airlocks 210a, 210b. The airlocks can seal in the vacuum pressure of the heat exchanger 100. The airlocks can permit transport of the bulk solid 101 into and out of the heat exchanger 100 without disrupting the vacuum pressure inside the heat exchanger 100.

A heat exchanger pump (not shown) removes water vapor 212 and carbon dioxide 214 from the heat exchanger 100 and establishes vacuum pressure in the heat exchanger 100. In some examples, multiple heat exchanger pumps are used. In some examples, vacuum is drawn through multiple connections between the pump or pumps and the heat exchanger. In some examples, vacuum is drawn through connections to the central tube 160, to an outer ring region 372 (shown in FIG. 3D), or both.

In some examples, the entire heat exchanger 100 between the airlocks 210a, 210b are held under constant vacuum with the heat exchanger pump. The vacuum level is at approximately 2 PSIA or less (e.g., 1.5 PSIA or less, 1.0 PSIA or less, 0.5 PSIA or less). The carbon dioxide is removed from the annulus by the heat exchanger pump. The carbon dioxide can then be stored or recycled.

Referring back to FIG. 1, the dry and lean bulk solid 101 flows toward from the heating region 140 to the cooler 150. Dry and carbon dioxide lean bulk solid 101 exits the desorber 130 at approximately 60 C or greater (e.g., 65 C or greater, 70 C or greater, 75 C or greater), and is gravity fed from the desorber 130 to the cooler 150.

Referring to FIG. 2, cooling fluid 206 circulates through the cooler 150 and absorbs heat from the bulk solid 101, cooling the bulk solid 101. The dry and carbon dioxide lean bulk solid 101 is cooled in the cooler 150 before the bulk solid is released from the vacuum created by the heat exchanger 100 in order to prevent the bulk solid 101 from oxidizing. Cooled and cleaned bulk solid 101 exits the cooler 150 through an airlock 210b. The airlock 210b preserves the vacuum pressure in the heat exchanger 100. The cooled and cleaned bulk solid 101 has a temperature of approximately ambient temperature. The bulk solid 101 thus exits the heat exchanger 100 dry of water and lean in carbon dioxide at approximately ambient temperature (e.g., 15 C, 20 C, 25 C).

Referring back to FIG. 1, the dry and lean bulk solid 101 exits the heat exchanger 100 through a heat exchanger outlet 114. The heat exchanger outlet 114 provides an egress for removal of the bulk solid 101 from the heat exchanger 100.

After exiting the heat exchanger 100, the dry and lean bulk solid 101 can undergo an adsorption process to adsorb carbon dioxide from the atmosphere. The bulk solid 101 can then be transported back to the inlet 106 of the heat exchanger to restart the drying and desorption process.

FIG. 3A illustrates a perspective view of an example heat exchanger unit 110 of a heat exchanger 100. FIG. 3B illustrates a perspective view of a cross section of an example heat exchanger unit 110 with fluid connections at an inner shell. FIG. 3C illustrates a perspective view of a cross section of an example heat exchanger unit 110 with fluid connections at an outer shell. FIG. 3D illustrates an overhead view of an example heat exchanger unit with fluid connections at an outer shell.

Referring to FIG. 3A, the heat exchanger unit 110 includes an annular structure including an inner shell 302 and an outer shell 308. The inner shell 302 defines a cylindrical annulus 360. During operation, a center axis of the cylindrical annulus is substantially aligned with the direction of gravity. The outer shell 308 is concentric with the inner shell 302. The outer shell 308 is coaxial with the inner shell 302. The outer shell 308 has a greater diameter than the inner shell 302. The outer shell 308 can have a diameter of 0.5 meters or greater (e.g., 1.0 meters or greater, 2.0 meters or greater). The outer shell 308 can have a diameter of 4.0 meters or less (e.g., 3.0 meters or less, 2.0 meters or less).

Referring to FIG. 3C, a first plate 304 and a second plate 306 define between them a conduit 332 for transporting fluid. The conduit 332 forms a spiral around the inner shell 302, as shown in FIG. 3D. The spiral extends from the inner shell 302 towards the outer shell 308. A space between turns of the spiral defines a channel 334 for passage of the bulk solid 101. The conduit 332 and the channel 334 are fluidly isolated from each other.

During operation, the bulk solid 101 enters the channel 334 at a first end of the channel 334 and exits the channel 334 at a second end of the channel 334. The bulk solid 101 passes from the first end of the channel to the second end of the channel due to gravity. The bulk solid 101 moves from a first channel of a first heat exchanger unit 110 to a second channel of a second heat exchanger unit 110 due to gravity. For example, the bulk solid 101 moves from a channel of the heat exchanger unit 110a, through a gas extraction region 170, to a channel of the heat exchanger unit 110b.

Referring to FIG. 3B, the heat exchanger unit 110 includes a gas extraction region 170. The gas extraction region 170 is between the inner shell 302 and the outer shell 308. The inner shell 302 includes openings 312 that permit passage of gasses from the gas extraction region 170 to the annulus 360. The openings 312 can be substantially aligned with the gas extraction region 170 in a plane perpendicular to the direction of gravity (e.g., the x-y plane).

Referring to FIG. 3D, the heat exchanger 100 includes a housing 370 enclosing the outer shell 308. The heat exchanger 100 includes an outer ring region 372 between the outer shell 308 and the housing 370. In some examples, the outer ring region 372 is maintained under vacuum pressure. In some examples, the housing is a pressure vessel.

Referring to FIG. 3B, the outer shell 308 includes openings 310 that permit passage of gasses from the gas extraction region 170 to the outer ring region 372. The openings 310, can be substantially aligned with the gas extraction region 170 in a plane perpendicular to the direction of gravity (e.g., the x-y plane).

gasses (e.g., water vapor, carbon dioxide) released from the bulk solid due to heat can be extracted from the gas extraction to the central tube 160, to the outer ring region 372, or both, by vacuum suction. The gasses can then be removed from the heat exchanger 100 through connections between the heat exchanger 100 and the heat exchanger pump.

The heat exchanger unit 110 includes a funneling element 320 in the gas extraction region 170. The funneling element 320 is configured to funnel the bulk solid 101 after the bulk solid exits the channel 334. The funneling element 320 includes an inner funnel member 316 attached to the inner shell 302 and an outer funnel member 314 attached to the outer shell 308. The inner funnel member 316 and the outer funnel member 314 are configured to funnel the bulk solid 101 away from the inner shell 302 and away from the outer shell 308.

Funneling the bulk solid 101 away from the inner shell 302 and the outer shell 308 increases the surface area that is exposed to vacuum suction from the central tube 160. Funneling the bulk solid 101 away from the inner shell 302 and the outer shell 308 prevents the bulk solid 101 from blocking or clogging the openings 310, 312. Funneling the bulk solid 101 away from the inner shell 302 and the outer shell 308 prevents the bulk solid 101 from falling through the openings 310, 312. In some examples, the openings 310, 312 are covered with a material such as a mesh material that prevents the bulk solid 101 from falling through the openings 310, 312.

As shown in FIG. 3B, the heat exchanger unit 110 can include fluid piping 322 that passes through the annulus 360. The fluid piping 322 can conduct fluids such as heating fluid, cooling fluid, or gasses. In some examples, the inner shell 302 includes an inlet aperture for ingress of fluid into the conduit 332, an outlet aperture for egress of the fluid from the conduit 332, or both.

As shown in FIG. 3C, the heat exchanger unit 110 can include fluid piping 324 that passes through the outer ring region 372. The fluid piping 324 can conduct fluids such as heating fluid, cooling fluid, or gasses. In some examples, the outer shell 308 includes an inlet aperture for ingress of fluid into the conduit 332, an outlet aperture for egress of the fluid from the conduit 332, or both.

In some examples, fluid (e.g., heating fluid or cooling fluid) is circulated through the conduit 332 from an inlet aperture at the inner shell 302 to an outlet aperture at the outer shell 308. In some examples, fluid is circulated through the conduit 332 from an inlet aperture at the outer shell 308 to an outlet aperture at the inner shell 302.

In some examples, the conduit 332 includes a first conduit layer and a second conduit layer that have different elevations. For example, as shown in FIG. 3C, the conduit 332 includes a first conduit layer 342 and a second conduit layer 344. The first conduit layer 342 can have a higher or lower elevation than the second conduit layer 344.

The fluid can be circulated through the first conduit layer 342 from an inlet aperture at the inner shell 302 towards the outer shell 308 and through the second conduit layer 344 from the outer shell 308 to an outlet aperture at the inner shell 302. For example, the fluid can circulate outwards through the spiral in the first conduit layer 342, move into the second conduit layer 344, and then circulate inward through the spiral in the second conduit layer 344.

The fluid can be circulated through the first conduit layer 342 from an inlet aperture at the outer shell 308 towards the inner shell 302 and through the second conduit layer 344 from the inner shell 302 to an outlet aperture at the outer shell 308. For example, the fluid can circulate inward through the spiral in the first conduit layer 342, move into the second conduit layer 344, and then circulate outward through the spiral in the second conduit layer 344.

A conduit having multiple conduit layers can enable external connections to be clustered together. For example, a conduit having two conduit layers can enable fluid to flow from the inner shell 302 towards the outer shell 308, and then return to the inner shell 302, such that the inlet aperture and the outlet aperture are both at the inner shell 302. Thus, inlet piping and outlet piping can both be located within the annulus 360 of a heat exchanger unit 110 and can transport fluid through the central tube 160. The inlet and outlet piping can thus penetrate the housing 370 of the heat exchanger 100 through a single penetration (e.g., at a top plate of the housing above the central tube 160).

In another example, a conduit having two conduit layers can enable fluid to flow from the outer shell 308 towards the inner shell 302, and then return to the outer shell 308, such that the inlet aperture and the outlet aperture are both at the outer shell 308. Thus, inlet piping and outlet piping can both be located within the outer ring region 372 of the heat exchanger 100. The inlet and outlet piping can thus penetrate the housing 370 of the heat exchanger 100 through a single penetration (e.g., at a top plate of the housing above the outer ring region 372).

By co-locating inlet and outlet piping, the number of penetrations through the housing 370 can be reduced. Reducing the number of penetrations through the housing 370 improves thermal insulation of the housing and improves the ability to establish and maintain vacuum pressure inside the heat exchanger 100. In some examples, all fluid piping can be located in the central tube 160. In some examples, all fluid piping can be located in the outer ring region 372. In some examples, some fluid piping can be located in the central tube 160 and other fluid piping can be located in the outer ring region 372. For example, heating fluid piping can be located in the central tube 160 and cooling fluid piping can be located in the outer ring region 372, or cooling fluid piping can be located in the central tube 160 and heating fluid piping can be located in the outer ring region 372.

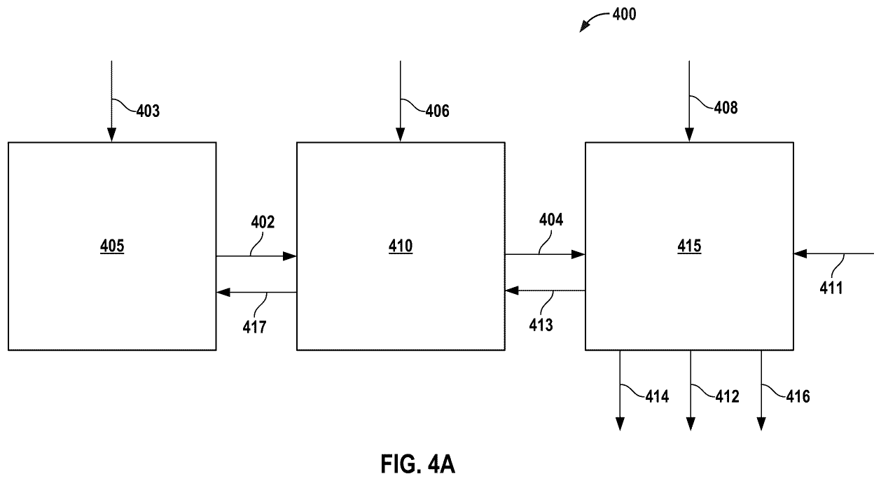

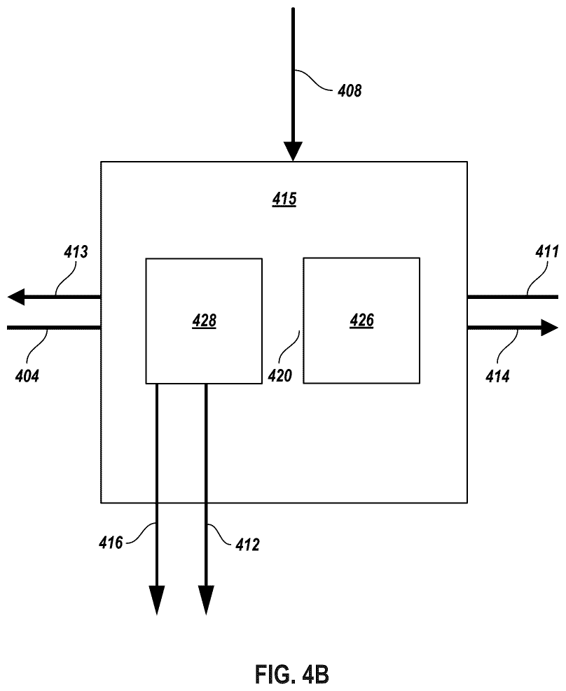

FIG. 4A is a schematic illustration of an example implementation of a carbon dioxide extraction system 400 that uses waste heat to provide energy for a carbon dioxide direct air capture (DAC) system 415. As illustrated, the carbon dioxide extraction system 400 includes an industrial process 405 that generates waste heat 402. In some implementations, the industrial process utilizes a power input 403. The waste heat 402 is supplied, in this example, to a thermal heat-reuse system 410 that also utilizes a power input 406.

The thermal heat-reuse system 410 provides a heated fluid 404 to a carbon dioxide DAC system 415. The carbon dioxide DAC system 415 also receives a power input 408 and an ambient airflow input 411. The carbon dioxide DAC system 415 outputs a carbon dioxide supply stream 412, a carbon dioxide-reduced airflow output stream 414, and demineralized water 416. As will be discussed in greater detail herein, DAC system 415 includes an adsorber system (e.g., that may optionally include a fluidized bed reactor or a silo adsorber) and a heat exchanger system (e.g., that may optionally include a spiral gravity fed desorber system).

Generally, the carbon dioxide extraction system 400 operates to utilize the heated fluid 404 as thermal energy that is generated from the waste heat 402 by the thermal heat-reuse system 410. The thermal energy in the heated fluid 404 is used by the carbon dioxide DAC system 415 to separate carbon dioxide captured from the ambient airflow input 411 and supply the separated carbon dioxide as the carbon dioxide supply stream 412. The heated fluid 404 is then returned via heated fluid return 413 to the thermal heat-reuse system 410, and the waste heat 402 is returned to the industrial process 405 via waste heat return 417. In some aspects, the carbon dioxide supply stream 412 can be provided as an injectant into a subterranean formation during hydrocarbon production operations. In some aspects, the injected carbon dioxide may be sequestered in the subterranean formation (with or without assisting in the hydrocarbon production operations).

The industrial process 405 may be any process that generates, as an output, thermal energy in the form of waste heat, i.e., energy that, unless captured, would otherwise be lost to, e.g., the ambient environment. As an example, the industrial process 405 may be a computer data center that, generally, houses computer systems and associated components, such as telecommunications and storage systems. In some aspects, a data center includes tens, hundreds, thousands, or even more server devices that generate heat, such as hardware processors, voltage regulators, memory modules, switches, and other devices that operate to provide a particular amount of information technology (IT) power. Such devices, typically, utilize electrical power to operate and output heat during operation. In order for such devices to operate correctly, the output heat must be captured in a cooling fluid flow (e.g., air, water, refrigerant) and expelled from the data center. For instance, air handling system (e.g., fans, cooling coils) may operate to capture the output heat in an airflow circulated over the heat-generating components. The output heat now within the airflow is transferred to a cooling liquid, e.g., within a cooling coil. The heat transferred to the cooling liquid is then typically rejected to the ambient environment as waste heat, such as through evaporative cooling systems, chiller/cooling tower systems, or otherwise. In this example, this waste heat takes the form of waste heat 402.

The example thermal heat-reuse system 410 utilizes the waste heat 402 and power input 408 to provide the heated fluid 404. The thermal heat-reuse system 410 includes a bank of heat pumps and a bank of heat exchangers to provide the heated fluid 404. By balancing the use of passive and active heating, power can be saved to provide the carbon dioxide DAC system 415 with the required temperatures of heated fluid 404. Generally, the thermal heat-reuse system 410 includes one or more vapor-compression cycles (“heat pumps”) to add thermal energy in the form of heat of compression to the waste heat 402 and transfer the sum of such energy to a fluid to generate the heated fluid 404 (e.g., a heated liquid). Generally, each heat pump and heat exchanger within the thermal heat-reuse system 410 operates to transfer thermal energy from a heat sink to a heat source, i.e., in an opposite direction of spontaneous heat transfer. The one or more heat pumps of the thermal heat-reuse system 410 use the power input 406 to accomplish the work of transferring energy from the heat source to the heat sink. Each heat pump in the thermal heat-reuse system 410 includes the primary components of two heat exchangers (one acting as an evaporator, one acting as a condenser), an expansion device (e.g., valve or fixed orifice), and a compressor (e.g., centrifugal, screw, reciprocating, scroll, or otherwise). Each of these components is fluidly coupled within a closed-loop refrigerant circuit in the heat pump.

As is generally known, in a vapor-compression heat pump cycle, a refrigerant exits a first heat exchanger in which heat from the refrigerant is released to a first medium. The refrigerant then enters a compressor in which it is compressed, and a heat of compression is added thereto. The refrigerant then enters a second heat exchanger in which heat from a second medium is added. The refrigerant then enters an expansion device and undergoes an isenthalpic pressure drop. The refrigerant completes the cycle by entering the first heat exchanger to release the heat of compression and the heat from the second medium to the first medium.

Although the present disclosure describes a vapor-compression heat pump cycle as a heat transfer system between a source of waste heat and a carbon dioxide DAC system, other thermodynamic cycles may also be used in place of (or along with) the described vapor-compression heat pump cycle. For example, one or more vapor-adsorption cycles may be used in place of (or along with) the described vapor-compression heat pump cycle. A vapor-adsorption cycle, for example, consists of a cycle of desorption-condensation-expansion-evaporation, followed by adsorption.

The carbon dioxide DAC system 415, generally, operates to pass the ambient airflow input 411 (which includes low concentrations of gaseous carbon dioxide) over or through one or more media (e.g., “filters”). In some aspects, one or more fans (not shown) utilize the power input 408 to circulate the ambient airflow input 411. The media or filter, in some aspects, includes a solid sorbent to which the atmospheric carbon dioxide in the airflow input 411 bonds. The sorbent that is saturated with carbon dioxide may be referred to as “rich sorbent.”

In the case of a solid sorbent, such as the bulk solid sorbent described in the present disclosure, as the airflow input 411 passes over the solid media or filter, atmospheric carbon dioxide within the airflow input 411 bonds to the media or filter. When the media or filter is saturated with carbon dioxide, it can be heated (e.g., to 600-620° C. or to 60-100° C.) to release the carbon dioxide for collection (as described herein).

Using thermal energy from the heated fluid 404, heat is applied to the solid or liquid sorbent, which breaks the bonds between the carbon dioxide and the sorbent. The separated carbon dioxide is provided as the carbon dioxide supply stream 412 from the carbon dioxide DAC system 415. The now-lean sorbent that is carbon dioxide free (i.e., the solid or liquid) is recycled back to capture more carbon dioxide from the ambient airflow input 411. The airflow output 414, typically, contains little to no carbon dioxide.

FIG. 4B shows an example carbon dioxide DAC system 415. The carbon dioxide DAC system 415 includes an adsorber system 426 and a desorber system 428.

The adsorber system 426 generally operates to pass the ambient airflow input 411 (which includes gaseous carbon dioxide) over or through one or more sorbents (e.g., in media or filters) under conditions at which the sorbent adsorbs CO2 from the air. In some embodiments, the sorbent is provided within a fluidized bed reactor.

The desorber system 428 generally operates to remove adsorbed carbon dioxide from sorbent material. The desorber system 428 can include, for example, the heat exchanger of FIG. 1.

The media, filter, or sorbent, in some aspects, includes a solid sorbent to which the atmospheric carbon dioxide in the airflow input 411 bonds. For example, the solid sorbent can be in a pelletized or powdered form. Alternatively, a liquid sorbent may be also passed over the media or filter to which the atmospheric carbon dioxide in the airflow input 411 bonds. The sorbent that is saturated with carbon dioxide may be referred to as “rich sorbent.” Rich sorbent 422 exits the adsorber system 426 and enters the desorber system 428. Carbon dioxide-reduced air exits the adsorber system 426 through the airflow output 414.

As the airflow input 411 passes over the sorbent (e.g., as a solid media and/or with a filter), atmospheric carbon dioxide within the airflow input 411 bonds to the sorbent. The airflow output 414 exits the system as carbon dioxide-reduced air and is released into the atmosphere. The airflow output 414, typically, contains little to no carbon dioxide. When the sorbent is saturated with carbon dioxide, it can be heated (e.g., to 70-120° C.) to release the carbon dioxide for collection.

In some aspects, a powdered sorbent material can be used. For example, silica-based sorbent powders are possible, e.g., porous silica functionalized with an amine compound. In some cases, metal oxide framework (MOF) powders can also be used. The degree of coarseness (granularity) of the powder can vary depending on the application. In some cases, particles with an average grain size in a range from 50 to 1,700 μm or from 50 to 3,000 μm can be used. In some examples, the sorbent powder is pelletized.

In some aspects, for example, if liquid sorbent is used, such liquid has a high affinity for carbon dioxide and is circulated over a non-reactive metal (or other material) filter. Once saturated with carbon dioxide, the liquid can be heated (e.g., to 800° C.) to release the carbon dioxide (as described herein). The liquid can then be reused to capture more carbon dioxide in a continual cycle.

The desorber system 428 uses thermal energy from the heated fluid 404 to apply heat to the solid or liquid rich sorbent 422. The heat dissolves the bonds between the carbon dioxide and the rich sorbent 422. The heated fluid return 413 exits the desorber system 428 in order to collect more heat from a process outside of the carbon dioxide DAC system. The separated carbon dioxide is provided as the carbon dioxide supply stream 412 from the carbon dioxide DAC system 415. The heat also dissolves bonds between water molecules and the rich sorbent 422, which exits the system as demineralized water output 416. The sorbent exiting the desorber system 428 may be referred to as “lean sorbent,” e.g., sorbent that is carbon dioxide free and, optionally, moisture free. Lean sorbent 420 (e.g., as a solid or liquid) exits the desorber system 428 and is recycled back to the adsorber system 426. The lean sorbent 420, in the filters of the adsorber system 426, captures more atmospheric carbon dioxide from the ambient airflow input 411. The demineralized water output 416, typically, contains little to no carbon dioxide.

Embodiments of the subject matter and the operations described in this specification can be implemented, in part, by digital electronic circuitry, or in computer software, firmware, or hardware, including the structures disclosed in this specification and their structural equivalents, or in combinations of one or more of them, in additional to the structures described above.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal.

In the present disclosure, ‘substantially’ or ‘approximately’ should be understood to mean being within 25%, 10%, 5%, 3% or 1% of a reference value.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. While this specification contains many specific implementation details, these should not be construed as limitations on the scope of any features or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system to transfer heat between fluid and a bulk solid, comprising:
a plurality of heat exchanger units, each heat exchanger unit comprising:
an annular structure comprising an inner shell and an outer shell; and
a first plate and a second plate defining therebetween a conduit for transporting the fluid, wherein the conduit forms a spiral around the inner shell, and the spiral extending from the inner shell towards the outer shell, a space between turns of the spiral defining a channel for passage of the bulk solid.

2. The system of claim 1, wherein the inner shell defines a cylindrical annulus of the annular structure, and an axis of the cylindrical annulus is substantially aligned with the direction of gravity during operation.

3. The system of claim 1, wherein, during operation, the bulk solid enters the channel at a first end of the channel and exits the channel at a second end of the channel, and the bulk solid passes from the first end of the channel to the second end of the channel due, at least in part, to gravity.

4. The system of claim 3, wherein the plurality of heat exchanger units are stacked such that, during operation, the bulk solid moves from a first channel of a first heat exchanger unit to a second channel of a second heat exchanger unit due, at least in part, to gravity.

5. The system of claim 4, wherein the first heat exchanger unit comprises a gas extraction region between the inner shell and the outer shell; and
Wherein, during operation, the bulk solid passes from the first channel through the gas extraction region to the second channel due, at least in part, to gravity.

6. The system of claim 5, wherein the first heat exchanger unit comprises a gas extraction region between the inner shell and the outer shell;
wherein during operation, the bulk solid passes from the second end of the first channel to the gas extraction region due, at least in part, to gravity.

7. The system of claim 6, wherein the inner shell defines an annulus of the annular structure, and the inner shell comprises a plurality of openings that permit passage of gasses from the gas extraction region to the cylindrical annulus.

8. The system of claim 6, wherein the system comprises a housing enclosing the outer shell, and an outer ring region between the outer shell and the housing; and
wherein the outer shell comprises a plurality of openings that permit passage of gasses from the gas extraction region to the outer ring region.

9. The system of claim 8, wherein the plurality of openings are substantially aligned with the gas extraction region in a plane substantially perpendicular to the direction of gravity.

10. The system of claim 6, wherein the first heat exchanger unit comprises a funneling element in the gas extraction region configured to funnel the bulk solid after the bulk solid exits the first channel at the second end of the first channel.

11. The system of claim 10, wherein the funneling element comprises an inner funnel member attached to the inner shell and an outer funnel member attached to the outer shell, and the inner funnel member and the outer funnel member are configured to funnel the bulk solid away from the inner shell and away from the outer shell.

12. The system of claim 6, wherein, during operation, gas is extracted from the bulk solid as the bulk solid passes through the gas extraction region.

13. The system of claim 12, wherein the gas comprises at least one of water vapor or carbon dioxide.

14. The system of claim 1, wherein the inner shell and the outer shell are concentric.

15. The system of claim 1, wherein the inner shell or the outer shell comprises an inlet aperture for ingress of the fluid into the conduit and an outlet aperture for egress of the fluid from the conduit.

16. The system of claim 1, wherein the system comprises a metering device configured to control a flow of the bulk solid into the channel.

17. The system of claim 1, wherein the bulk solid comprises a sorbent material configured to adsorb carbon dioxide from air.

18. The system of claim 1, wherein the fluid comprises a cooling fluid or a heating fluid.

19. The system of claim 1, comprising:
a heating region comprising a first subset of the plurality of heat exchanger units, wherein a first fluid transported through respective conduits of the first subset of the plurality of heat exchanger units comprises a heating fluid; and
a cooling region comprising a second subset of the plurality of heat exchangers, wherein a second fluid transported through respective conduits of the second subset of the plurality of heat exchanger units comprises a cooling fluid.

20. A method for transferring heat between fluid and a bulk solid, comprising:
circulating a fluid through a conduit within an annular structure comprising an inner shell and an outer shell, the conduit being between a first plate and a second plate, wherein the conduit forms a spiral around the inner shell, and the spiral extends from the inner shell towards the outer shell;
feeding the bulk solid into a channel defined by space between turns of the spiral; and
desorbing carbon dioxide from the bulk solid by transferring heat from the fluid to the bulk solid during passage of the bulk solid through the channel.
